(19) United States
(12) Patent Application Publication
(10) Pub. No.: US 2020/0176906 A1
(43) Pub. Date: Jun. 4, 2020

(54) CONNECTOR SYSTEM

(71) Applicant: SFD Systems Limited, Suffolk (GB)

(72) Inventors: Ian PAGANO, Suffolk (GB); Nicola KAY, Great Paxton (GB); Graham DAVIES, Suffolk (GB); Chris BROWN, Suffolk (GB)

(21) Appl. No.: 15/754,773

(22) PCT Filed: Aug. 24, 2016
(86) PCT No.: PCT/GB2016/052627

§ 371 Date: Feb. 23, 2018

(30) Foreign Application Priority Data
Aug. 24, 2015 (GB) 1515029.5

(51) Int. Cl. H01R 12/78; H01R 12/59; A47B 96/00; G09F 3/20; H01R 25/14

(52) U.S. Cl. CPC H01R 12/78; H01R 12/592; H01R 25/14; G09F 3/204; A47B 96/00

(57) ABSTRACT

An electronic shelving display system comprises at least one shelf support 62, at least one electrically conductive track 4, 104 comprising a plurality of electrically conductive elements 40, mountable to the shelf support, at least one connector 2, 102 for an electrically conductive track, and at least one shelf 64. The connector 2, 102 comprises one or more cables 6, 106; at least one electrical contact 8 coupled to each cable; and a housing 16 configured to engage the track and urge the electrical contacts into contact with the electrical conductors. The connector 2, 102 is releasably engageable with the electrically conductive track 4, 104 to provide an electrical connection to allow for the supply of power and/or data to the shelf 64. A connector for an electrically conductive track, a method of making an electrical connection, and an electrically conductive track are also provided.

The present invention relates to a system for providing an electrical connection. More specifically, it relates to a system for providing an electrical connection between an electrically conductive track and one or more flexible cables. Such a system may advantageously be used in order to provide power and data to an electronic shelving display system.

### BACKGROUND OF THE INVENTION

The necessity of providing accurate product information, in particular pricing information, to customers in a retail environment makes shelving systems and shelf edge labels an integral part of any retail store.

In order to reduce the costs of manually updating shelf edge labels and improve the accuracy of displayed product information, there is a growing desire to provide shelving systems incorporating electronic devices, particularly networked electronic devices such as electronic shelf label displays.

Such networked devices require a supply of power, which may be provided either by batteries, or by hard-wired power lines which are typically connected to the device through the shelving. Battery powered devices provide a superior degree of flexibility, as the device may be located anywhere throughout a store or warehouse without the issue of having to provide a power supply. The lifetime of the battery is, however, a limiting feature, as the necessary replacement of batteries on a regular basis is both time-consuming and costly.

Hard-wired power supplies do not have a finite lifetime, but are more expensive to install, and can limit the positions at which a shelf edge device may be located to those positions with an available power outlet.

Similarly, data must be provided to the networked devices in order for each device to update the displayed information when required. Data may be provided wirelessly or through hard-wiring. Wireless formats allow flexibility in the positioning of networked devices, but potentially leave the system open to hacking or signal jamming. Hard-wired data supply is more secure, but as with hard-wired power, it is costly to install and can restrict the positioning of networked devices.

In order to accommodate store re-arrangements and changing product displays, retail shelving systems are required to be flexible in both the number of shelves in a given section, the heights at which said shelves are placed, and the positions of electronic shelf label displays on the shelves. Any hard-wired electrical system must therefore provide a reliable supply of power and data on-demand to shelves in a variety of configurations, and to electronic shelf label displays mounted in various positions on those shelves.

It is important that any hard-wired electrical system does not interfere with the products displayed on a shelf, or become easily dislodged when products are moved on the shelf. In order to allow for quick and easy reconfiguration of shelving, a hard-wired electrical system must allow for simple connection and removal. Such a system should also be robust enough to survive incorrect handling by users.

It is an object of the present invention to provide a system for power and/or data provision that is safe, easy to use, and meets the above described requirements. It is a further object of the invention to provide a safe and secure supply of power and/or data to an electronic shelving display system such that a high volume of data may be transmitted to a plurality of networked displays.

### SUMMARY OF THE INVENTION

The invention in its various aspects is defined in the appended independent claims, to which reference should be made. Advantageous features are set forth in the dependent claims.

In a first aspect of the present invention, there is provided a connector for an electrically conductive track, the connector comprising one or more cables, at least one electrical contact coupled to each cable, and a housing configured to engage a track and urge each electrical contact into contact with the track, wherein the housing is releasably engageable with the track.

The connector is preferably configured to releasably clip on, or releasably slide on, to a track. The connector may comprise a projection configured to slide in a groove on the track.

In a preferred embodiment of the connector, the housing comprises at least one retaining arm configured to engage with a retaining lip on a track. Alternatively, the at least one retaining arm may engage with an underside of the track, or with a recess on the track.

The at least one retaining arm may be rigid or resiliently deformable. In order to attach to, and detach from, the track, the housing preferably comprises at least one handle coupled to the retaining arm, wherein movement of the at least one handle moves the retaining arm and allows it to disengage from the track.

The retaining arm and/or the handle may be coupled to the housing by a torsion spring, such that the retaining arm and/or handle are movable with respect to the housing, but are biased to an engaged position by the torsion spring. Alternatively, the retaining arm and/or handle may be coupled to the housing by a living hinge, such that the arm may move between a disengaged position and an engaged position in which the arm engages the track. The at least one retaining arm may be connected to the housing by a sliding mechanism, such that the arm is slidable between a disengaged position and an engaged position in which the arm engages the track. The at least one retaining arm may be removable from the housing.

The connector may comprise a retaining lip and no retaining arms, such that it is engageable with a track which comprises at least one retaining arm. Alternatively, the connector may engage with the track by way of a magnetic coupling, or a fabric hook and loop fastener. In a particularly preferred embodiment, the housing comprises two resiliently deformable retaining arms, each coupled to a handle, at opposing ends of the housing. Movement of the two handles towards one another in a ‘pinching’ action exerts a lever action, or torque, on the retaining arms, resiliently deforming the arms so as to increase the distance between them. When the handles are released, the arms return to their original position.

Movement of the at least one handle may preferably allow the connector to be moved onto, along or off a track. In order to engage the connector with the track, in use, the handle is moved so as to resiliently deform the retaining arm to which it is coupled. The connector is then placed on the track and the handle is released, such that the retaining arm returns to its original shape and engages a retaining lip on the track. In order to release the connector from the track, in use, the handle is moved so as to resiliently deform the at least one retaining arm such that it disengages from the retaining lip on the track. The connector can then be removed from the track before releasing the handle so that the retaining arm returns to its original shape.

In a preferred embodiment of the connector, the housing comprises a main portion and a retaining portion. The retaining portion is moveable between a first position relative to the main portion, in which the one or more cables are not retained in the housing, and a second position, in which the one or more cables are retained in the housing. Preferably the at least one cable is retained between the main portion and the retaining portion when the retaining portion is in the second position. The main portion and the retaining portion may optionally be separable or they may be joined but movable relative to one another.

The retaining portion may be hinged to the main portion. Alternatively the retaining portion may be a sprung section of the housing that is biased to compress the one or more cables against the main portion. In one preferred embodiment, the main portion comprises an aperture and the retaining portion comprises a wedge. In order to assemble the connector, the at least one cable is arranged to enter the housing through the aperture, such that subsequent insertion of the wedge into the aperture traps the at least one cable between the main portion and the retaining portion and holds it in place. The at least one cables may be released from the housing, in use, by removing the wedge from the main portion.

The retaining portion may be a resiliently deformable wedge and the main portion may be shaped such that, when the retaining portion is inserted into the main portion it is compressed until it reaches an inserted position where it can expand to engage the main portion. The retaining portion may be releasable by a user.

Preferably the at least one electrical contact is a resilient electrical contact. Preferably each of the at least one electrical contacts comprises a leaf spring. The dimensions of the electrical contact are chosen such that, when the connector is engaged with a track, the electrical contact is urged into contact with the track so as to make an electrical connection between the track and the electrical contact. The portion of the electrical contact arranged, in use, to abut the track preferably comprises a rounded, or convex, surface, which is preferably resiliently deformable.

Preferably the housing is configured to provide support to the at least one electrical contact so that, when the connector is engaged with a track, the electrical contact is urged into contact with the track. Preferably the electrical contact is urged into contact with an electrically conductive element on the track. The housing may comprise a resilient member configured to sit behind the electrical contact, or above the electrical contact when the connector is connected to the track, so that the resilient member urges the contact against the track. The resilient member may be formed as part of either the main portion or the retaining portion. The presence of a resilient member to provide support to the electrical contact may advantageously increase the lifetime of an electrical contact, by reducing the mechanical stress on the electrical contact and reducing the resilience required of the contact. The additional support may also ensure that the contacts are held evenly and firmly against the track, so as to provide a reliable electrical connection.

The resilience of the electrical contacts preferably urges the housing away from the track, so that when the resilient arms are disengaged from the track the connector is urged away from the track. This may advantageously mean that in order to engage the connector with the track, a user must exert a deliberate pressure to urge the connector against the track against the spring force of the resilient electrical contacts, thus lessening the chance of connections being made accidentally. Particularly preferably, the spring force exerted by the resilient electrical contact onto the track is such that the connector is movable along the track while maintaining electrical contact between the connector and the track, but without scratching or otherwise damaging the surface of the track.

In a preferred embodiment of the connector, the connector comprises a plurality of resilient electrical contacts spaced laterally from one another. Particularly preferably, each resilient electrical contact is configured to contact a corresponding electrical conductor on a track when the connector is engaged with said track.

In alternative embodiments, the electrical contacts may not be resiliently deformable, but may rather be held against the track by frictional forces, or compressed against the track by a sprung member in the housing. The electrical contacts may comprise conductive elements attached to the base of the housing.

The connector may preferably comprise one or more cables each containing one or more electrically conductive wires. Each wire may carry a different electrical signal, allowing the connector to provide an electrical connection for a plurality of different electrical signals simultaneously. Each electrical signal may preferably be carried by a pair of electrical conductors, which may be electrically conductive wires or electrically conductive cables, wherein one conductor has a positive polarity and the other conductor has a negative polarity.

The one or more cables are preferably flexible.

Particularly preferably, the connector may comprise one or more ribbon cables, each containing multiple wires.

In a preferred embodiment, the connector comprises one ribbon cable, comprising a plurality of electrically conductive wires. The ribbon cable is retained between the main portion and the retaining portion of the housing, and the portion of the ribbon cable retained within the housing is coupled to a plurality of resilient electrical contacts. Preferably each electrical contact is electrically connected to one electrically conductive wire such that, when the connector is engaged with a track, an electrical connection is provided from the track through the resilient electrical contacts to the electrically conductive wire.

In order to ensure that, in use, the connector connects to a track in the intended way and in the intended orientation, the housing of the connector is preferably keyed to fit a corresponding portion of a track. As a result of this, the connector will engage with a track in only one predetermined configuration, or orientation, such that the keyed portion of the connector meshes with the corresponding keyed portion of a track. Where the connector is, in use, providing a connection for a plurality of different electrical signals, it is important to identify the way in which the signals will be delivered out of the connector. For this reason, the keyed feature of the connector advantageously allows the electrical connection between the connector and a track to be made in a consistent and identifiable way.

In use, the connector may receive an electrical signal, or signals, from a track to which the connector is engaged. The electrical signal may be transmitted to the connector by way of the electrical connection between the track and the resilient electrical connectors, and then transmitted along the one or more cables or electrically conductive wires. Preferably, the one or more cables or electrically conductive wires may be coupled to one or more electrical components, such that the signal is transmitted to the one or more electrical components. The one or more electrical components may comprise an electrically conductive track, or any other electrically conductive component or electrically powered device.

Particularly preferably, the connector may be a double-ended connector, wherein a first housing retains a first end of the one or more cables, and a second housing retains a second end of the same one or more cables. Preferably, the first housing is engageable with a first electrically conductive track, and the second housing is engageable with a second electrically conductive track, in order to provide an electrical connection between the first and second tracks.

Preferably, the connector may be assembled without the use of screws.

In a second aspect of the present invention, there is provided an electrically conductive track comprising a plurality of electrically conductive elements and an electrically insulating base, wherein the base is keyed to fit a portion of a corresponding connector structure.

The electrically conductive elements may comprise electrically conductive wires. Preferably the electrically conductive elements are ribbon conductors.

Preferably, the track may be substantially larger in a longitudinal dimension than in a lateral dimension, such that the length of the track is much greater than its width.

The electrically conductive track may, in use, provide a supply of power, or data, or power and data to an electrical system.

In a preferred embodiment, the track may transmit both power and data, where at least one electrically conductive element is used for the transmission of power and at least one electrically conductive element is used for the transmission of data. Particularly preferably, at least two electrically conductive elements are used to transmit power, wherein one electrically conductive element has a positive polarity and one electrically conductive element has a negative polarity, and at least two electrically conductive elements are used to transmit data, wherein one electrically conductive element has a positive polarity and one electrically conductive element has a negative polarity. The track may comprise one or more electrically conductive elements that are electrically grounded.

Preferably, the electrically conductive elements are embedded in, or supported by, the electrically insulated base such that a portion of the electrically conductive elements is exposed. Particularly preferably, the plurality of electrically conductive elements are laterally spaced from one another, and extend parallel to one another in a longitudinal direction along the track. The electrically conductive elements may advantageously be exposed so that each electrically conductive element forms a continuous electrically conductive strip along the entire length of, or a portion of, the track.

Preferably the track comprises at least one retaining lip, or ridge, or recess, configured to engage with the at least one retaining arm of a connector. Particularly preferably the track comprises two retaining lips, wherein one lip is disposed along each longitudinal edge of the track. Preferably the at least one retaining lip is disposed along the entire length of the track.

The track may additionally comprise an electrically insulating track-cover configured to cover the electrically conductive elements. The track cover may advantageously reduce the risk, in use, of a user receiving an electric shock when the electrically conductive elements are transmitting an electrical signal, and are therefore electrically live.

The track-cover may clip on or slide on to the track, or may be hinged to the track, and may advantageously comprise at least one openable portion, through which a connector may connect to the track. The openable portion may comprise a portion of the track-cover which is removable, hinged, or otherwise openable to create an opening in the track-cover which, in use, exposes a section of the track. Preferably, the openable portions are sized so that a connector may fit through the opening and connect to the track. The track-cover may advantageously comprise a plurality of openable portions disposed at predetermined positions along the track, such that connectors may connect to the track at a plurality of different positions.

The track-cover may be configured to clip-together, or otherwise engage with, one or more similar or identical track-covers in a modular fashion, so as to cover various lengths of electrically conductive track.

In a third aspect of the present invention, there is provided a system comprising an electrically conductive track comprising a plurality of electrically conductive elements, and a connector comprising one or more cables, at least one electrical contact coupled to each cable, and a housing configured to engage the track and urge the electrical contacts into contact with the electrically conductive elements. The connector is releasably engageable with the track.

The system may preferably comprise a connector for an electrically conductive track according to the first aspect of the present invention, and an electrically conductive track according to the second aspect of the present invention.

The electrically conductive elements are preferably ribbon conductors, and the electrical contacts are preferably resilient electrical contacts. The track and the connector are preferably keyed so that the connector is engageable with the track in only one predetermined orientation.

Preferably, the at least one resilient electrical contact comprises a leaf spring. The dimensions and resilience of the resilient electrical contact are preferably chosen such that, when the connector is engaged with the track, the resilient electrical contact is urged into contact with the track so as to make an electrical connection between the track and the resilient electrical contact. The resilient electrical contact preferably comprises a rounded, or convex, surface which is configured to abut the track when the connector is engaged with the track. Particularly preferably, the spring force exerted by the resilient electrical contact onto the track is such that the connector is movable along the track while maintaining electrical contact between the connector and the track, but without scratching or otherwise damaging the surface of the track.

As described in relation to the first aspect, preferably the housing is configured to provide support to the at least one electrical contact so that, when the connector is engaged with a track, the electrical contact is urged into contact with the track. Preferably the electrical contact is urged into contact with an electrically conductive element on the track. The housing may comprise a resilient member configured to sit behind the electrical contact, or above the electrical contact when the connector is connected to the track, so that the resilient member urges the contact against the track. The resilient member may be formed as part of either the main portion or the retaining portion. The presence of a resilient member to provide support to the electrical contact may advantageously increase the lifetime of an electrical contact, by reducing the mechanical stress on the electrical contact and reducing the resilience required of the contact. The additional support may also ensure that the contacts are held evenly and firmly against the track, so as to provide a reliable electrical connection. In a preferred embodiment, the connector comprises a plurality of resilient electrical contacts spaced laterally from one another and the track comprises a plurality of electrically conductive elements spaced laterally from one another. Particularly preferably, each resilient electrical contact is configured to contact a corresponding electrically conductive element on the track when the connector is engaged with the track.

Preferably the connector is engageable with the track by way of a clip-on mechanism, and/or a slide-on mechanism.

The track may advantageously comprise at least one retaining lip, and the housing of the connector may advantageously comprise at least one retaining arm configured to mate with the retaining lip so as to engage the connector with the track. The retaining arm is preferably resiliently deformable.

In a preferred embodiment, the track comprises two retaining lips, with one retaining lip disposed along each opposing longitudinal edge of the track. Preferably the retaining lips extend the entire length of the track. Preferably the connector comprises two resiliently deformable retaining arms disposed at opposite ends of the housing. Particularly preferably, the retaining arms are separated by a distance approximately equal to the width of the track, such that the retaining arms are engageable with the retaining lips on the edges of the track.

Preferably, the housing comprises at least one handle coupled to the retaining arm, movable so as to resiliently deform the retaining arm. In a preferred embodiment, the housing comprises two resiliently deformable retaining arms, each coupled to a handle, at opposing ends of the housing. Movement of the two handles towards one another in a ‘pinching’ action exerts a lever action on the retaining arms, resiliently deforming the arms so as to increase the distance between them. When the handles are released, the arms return to their original position. The connector can therefore be engaged to, or disengaged from, the track by moving the handles towards one another and moving the connector on or off the track.

As described according to the second aspect of the present invention, the track preferably comprises a plurality of electrical conductive elements embedded in, or supported by, an electrically insulated base. Preferably a portion of the electrically conductive elements is exposed, and particularly preferably the plurality of electrically conductive elements are laterally spaced from one another and extend parallel to one another in a longitudinal direction along the track. The electrically conductive elements may advantageously form a plurality of continuous electrically conductive strips along the entire length of, or a portion of, the track.

The electrically conductive track may, in use, provide a supply of power, or data, or power and data to an electrical system.

In a preferred embodiment, the track may transmit both power and data, where at least one electrically conductive element is used for the transmission of power and at least one electrically conductive element is used for the transmission of data. In an alternative embodiment, one electrically conductive element may carry both power and data in a power-over-data, or data-over-power, configuration.

Particularly preferably, at least two electrically conductive elements are used to transmit power, wherein one electrically conductive element has a positive polarity and one electrically conductive element has a negative polarity. Particularly preferably, at least two electrically conductive elements are used to transmit data, wherein one electrically conductive element has a positive polarity and one electrically conductive element has a negative polarity. The track may comprise one or more electrically conductive elements that are electrically grounded.

Preferably the connector may engage with the track at a plurality of positions along the length of the track. Particularly preferably the connector may engage with the track at any position along its length, such that an electrical connection is formed between the track and the connector. Preferably a plurality of connectors may be engaged with a track at different positions along its length.

As described for the second aspect of the invention, the system may additionally comprise an electrically insulating track-cover. The track-cover preferably comprises at least one retaining arm configured to mate with the retaining lip on the track so as to engage the track-cover with the track. The track-cover may comprise at least one openable portion, through which the connector may connect to the track. The track-cover may advantageously protect the track, in use, from contact with liquid and other materials.

The track may be flexible or substantially rigid. Preferably, the one or more cables of the connector is flexible, such that the connector may provide a flexible electrical connection to a substantially rigid track.

Particularly preferably, the connector is a double-ended connector, so that a first end of the one or more cables is retained in a first housing, and a second end of the one or more cables is retained in a second housing. In a preferred embodiment of the invention, the first housing may engage with a first electrically conductive track, and the second housing may engage with a second electrically conductive track, such that an electrical connection is provided from the first track, through the connector, to the second track.

The present invention proposes, in general terms, to transmit power and/or data entered at a central location to networkable devices on a shelving system over electrically conductive tracks mounted on the shelving system. In particular, the networkable devices may comprise electronic shelf label displays.

In a fourth aspect of the present invention, an electronic shelving display system is provided. The electronic shelving display system comprises the system according to the third aspect of the present invention, and additionally comprises at least one shelf support and at least one shelf. According to this fourth aspect, the electrically conductive track is mounted to the shelf support, and a second electrically conductive track is mounted to the shelf. The connector is engageable with both the electrically conductive track and the second electrically conductive track, so as to provide an electrical connection between the two tracks and allow for the supply of power and/or data to the shelf.

Preferably the connector is a double-ended connector, wherein a first housing retains a first end of the one or more cables, and a second housing retains a second end of the same one or more cables. Preferably, the first housing is engageable with the electrically conductive track, and the second housing is engageable with a second electrically conductive track, in order to provide an electrical connection between the first and second tracks. The second electrically conductive track may be a track according to the second aspect of the present invention. Preferably the electrically conductive track and the second electrically conductive track are substantially identical.

The electronic shelving display system may preferably comprise one or more networked electronic devices, which may be electronic shelf displays. Preferably, the one or more networked electronic devices may be electrically connected to an electrically conductive track. Particularly preferably, the one or more networked electronic devices are engageable with the second electrically conductive track.

According to this aspect of the present invention, a shelving system is provided, comprising at least one shelf support and at least one shelf, wherein the shelf may be mounted on the shelf support at a plurality of positions, or heights. An electrically conductive track is mounted to the shelf support such that the track runs along the length of the shelf support. A second electrically conductive track, substantially identical to the electrically conductive track, is mounted on the shelf. A connector is provided, wherein the connector comprises two connector housings, wherein a first connector housing is connected to a first end of a cable, and a second connector housing is connected to a second end of a cable. The second electrically conductive track may be mounted to a shelf front, and may comprise a display mount for one or more networked electronic devices. Preferably, one or more networked electronic devices are connected to the second electrically conductive track on the shelf.

The system may comprise an electrically insulating track-cover, according to the second and third aspects of the invention. The system may additionally comprise a second electrically insulating track-cover configured to cover the second electrically conductive track. The second electrically insulating track-cover may comprise a plurality of openable portions, through which networked electronic devices may connect to the second electrically conductive track. Preferably, the second electrically insulating track-cover covers the second electrically conductive track, and also any networked electronic devices engaged thereto. Preferably the cover is transparent.

Preferably, the system comprises a plurality of shelves mounted on the same shelf support.

In use, power and data are supplied to the electrically conductive track mounted on the shelf support, and the shelf is mounted on the shelf support at the desired position. The first connector housing is engaged with the electrically conductive track, and the second connector housing is engaged with the second electrically conductive track, so as to provide an electrical connection between the two tracks. Power and data are transmitted to the second electrically conductive track via the connector, and from the second electrically conductive track to the one or more electronically networked devices on the shelf.

An electronic shelving display system according to the present invention may advantageously be created by mounting the system of the present invention onto existing, non-electronic, shelving systems, such as those contained in the majority of retail stores. The possibility of retro-fitting the present invention may allow installation of the system according to the present invention at a low cost, and with the creation of no waste, such as that that might be generated by replacing existing shelving systems altogether.

The electronic shelving display system may advantageously comprise the connector, and/or the track, and/or the system according to the present invention.

The electronic shelving display system may comprise at least one shelf support; at least one electrically conductive track, comprising a plurality of electrically conductive elements, mountable to the shelf support; at least one connector for an electrically conductive track; and at least one shelf. The connector comprises one or more cables; at least one electrical contact coupled to each cable; and a housing configured to engage the track and urge the electrical contacts into contact with the electrical conductors, and the connector is releasably engageable with the electrically conductive track to provide an electrical connection to allow for the supply of power and/or data to the shelf.

The connector housing of the electronic shelving display system may comprise a main portion and a retaining portion, wherein the retaining portion is moveable between a first position relative to the main portion, in which the one or more cables are not retained in the housing, and a second position, in which the one or more cables are retained in the housing. With the retaining portion in the second position, the at least one cable is preferably retained between the main portion and the retaining portion.

In a preferred embodiment, the retaining portion preferably comprises a resiliently deformable wedge insertable into the main portion. The retaining portion preferably comprises a notch which is releasably engageable with a corresponding part of the main portion, such that the notch engages with the main portion when the retaining portion is in the second position, and disengages with the main portion when the retaining portion is in the second position.

The electronic shelving display system may advantageously comprise a second electrically conductive track mountable to the shelf, wherein the second electrically conductive track comprises an electrically conductive track according to the present invention. The electronic shelving display system may also comprise a double-ended connector comprising a first housing according to the present invention and a second housing according to the present invention. Preferably the first and second housings are substantially identical. The first housing may be advantageously engageable to the electrically conductive track, and the second housing may be advantageously engageable to the second electrically conductive track, so as to provide an electrical connection between the two tracks.

The electronic shelving display system may advantageously comprise one or more shelf mounts, mountable to the one or more shelves, and one or more electronic shelf label displays, engageable with the shelf mounts so as to receive power and/or data from the shelf mounts. The one or more shelf mounts preferably comprise electrically conductive tracks according to the present invention.

In a fifth aspect of the present invention, there is provided a method of making an electrical connection comprising the steps of providing an electrically conductive track, wherein the track comprises a plurality of electrically conductive elements and is keyed to be engageable with a corresponding connector; and engaging an electrical connector with the track, so that resilient electrical contacts in the connector are urged into contact with the electrically conductive elements in the track.

Preferably, the method may comprise the steps of providing a connector according to the first aspect of the present invention, and an electrically conductive track in accordance with the second aspect of the present invention, and engaging the connector with the track.

Alternatively, the method may comprise the step of providing a system according to the third aspect of the present invention, and engaging the connector with the electrically conductive track.

In a sixth aspect of the present invention, there is provided a system comprising a display mount connected to or forming part of a data network, and a plurality of electronic shelf label displays, mountable on the display mount. The display mount preferably comprises an electrically conductive track comprising four electrically conductive elements which are electrically separate from one another. Two electrically conductive elements are used for the transmission of power and two electrically conductive elements are used for the transmission of data. The four electrically conductive elements may extend parallel to one another. The displays preferably comprise four electrical contacts and a housing configured to engage the track and urge the electrical contacts into contact with the electrically conductive elements. The displays are advantageously releasably engageable with the electrically conductive track to provide an electrical connection to allow for the supply of power and/or data to the displays. The displays may be engageable with the display mount using a snap fit or interference fit. Preferably, the displays are releasable from the conductive track without the need for any tools.

The electronic shelf label display may be a price display unit (PDU). The electronic shelf label display may comprise a processor. Each electronic shelf label display may have a distinct network address. Preferably, the electronic shelf label displays may be colour displays, such that each electronic shelf label display has a display screen capable of displaying images and videos in full colour. The display may also comprise audio capability, such as a built in speaker. The display may optionally comprise a motion sensor and/or wireless capability allowing transmission of data to compatible devices in the vicinity. The display may be a liquid crystal display, or a light emitting diode, or a thin film transistor (TFT) display, or an OLED display.

Preferably the electrical contacts on the displays are formed on the rear of the display. spring-loaded, or sprung, so that the electrical contacts are urged into contact with the electrically conductive elements when the display is mounted on the display mount. Particularly preferably, the system may comprise at least one connector for an electrically conductive track, as described in relation to the other aspects of the invention. The connector preferably comprises: one or more cables; at least one electrical contact coupled to each cable; and a connector housing configured to engage the track and urge the electrical contacts into contact with the electrically conductive elements. The connector is preferably releasably engageable with the electrically conductive track to provide an electrical connection to allow for the supply of power and/or data to the display mount. Preferably the display mount comprises a display cover, which may be the second electrically insulating track-cover described according to the other aspects of the invention. Preferably the display cover covers the display mount and the electrically conductive track of the display mount, as well as any displays engaged thereto. Preferably the cover is transparent. Particularly preferably, the cover may be lockable, such that the cover can be engaged with the display mount and locked in place. The cover may engage with the display mount by sliding into notches in the display mount.

Features described in relation to the first to fifth aspects of the invention may apply equally to the sixth aspect of the invention, and vice versa.

### BRIEF DESCRIPTION OF THE DRAWINGS

The invention is described in more detail, by way of example, with reference to the accompanying drawings, in which:

FIG. 1 shows a perspective view of a resilient electrical contact in accordance with the present invention;

FIG. 2 shows a perspective view of the main portion of a connector housing in accordance with the present invention;

FIG. 3 shows a front view of the main portion of the connector housing of FIG. 2;

FIG. 4 shows a top view of the main portion of the connector housing of FIG. 2;

FIG. 5 shows a partially exploded view of a connector and an electrically conductive track in accordance with the present invention;

FIG. 6 shows a perspective view of a connector engaged with an electrically conductive track in accordance with the present invention;

FIG. 7 shows a top view of a connector engaged with an electrically conductive track in accordance with the present invention;

FIG. 8 shows a front view of a connector engaged with an electrically conductive track in accordance with the present invention;

FIG. 9 shows a side view of a connector engaged with an electrically conductive track in accordance with the present invention;

FIG. 10 shows an electrically-insulating track-cover in accordance with the present invention;

FIG. 11a shows an electronic shelving display system according to the present invention;

FIG. 11b shows a magnified view of the electronic shelving display system of FIG. 11a;

and

FIG. 11c shows a magnified view of the electronic shelving display system of FIGS. 11a and 11b

FIG. 12 shows a schematic diagram of the architecture of a system in accordance with the present invention;

FIG. 13 shows a schematic diagram of a store integrated routing device in accordance with the present invention.

### DETAILED DESCRIPTION OF THE INVENTION

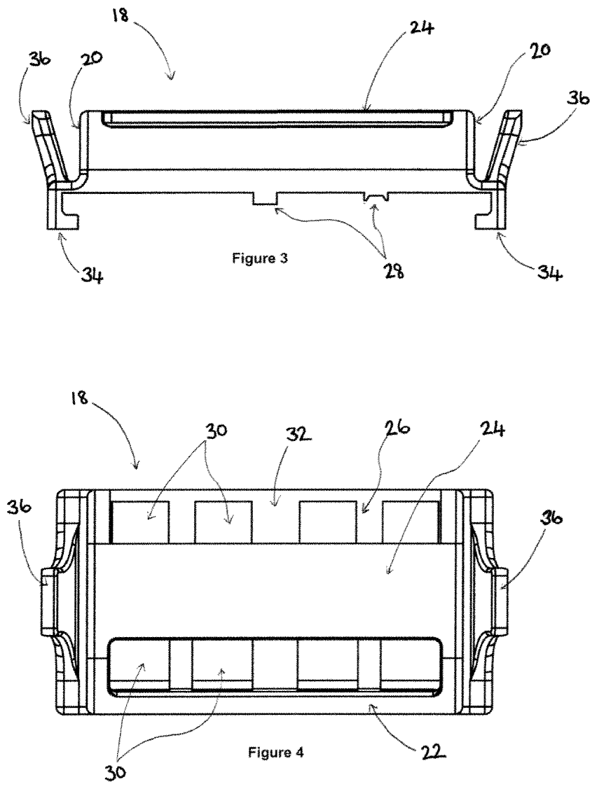

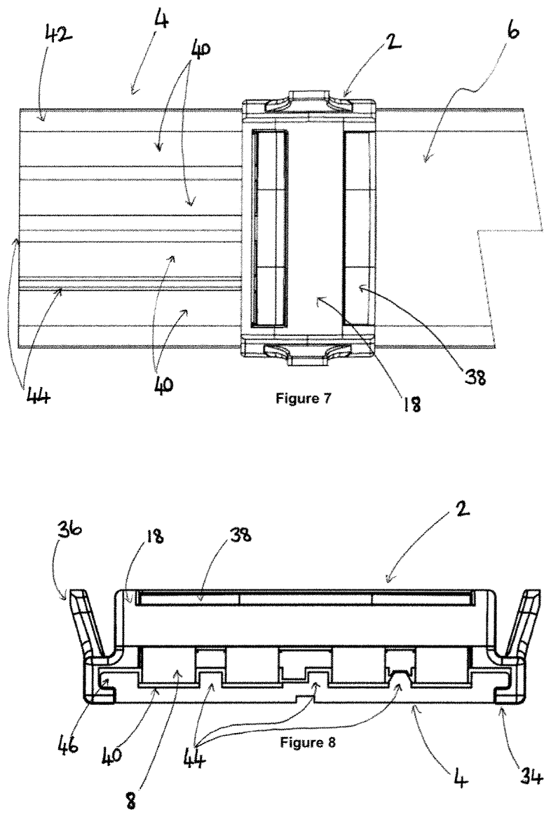

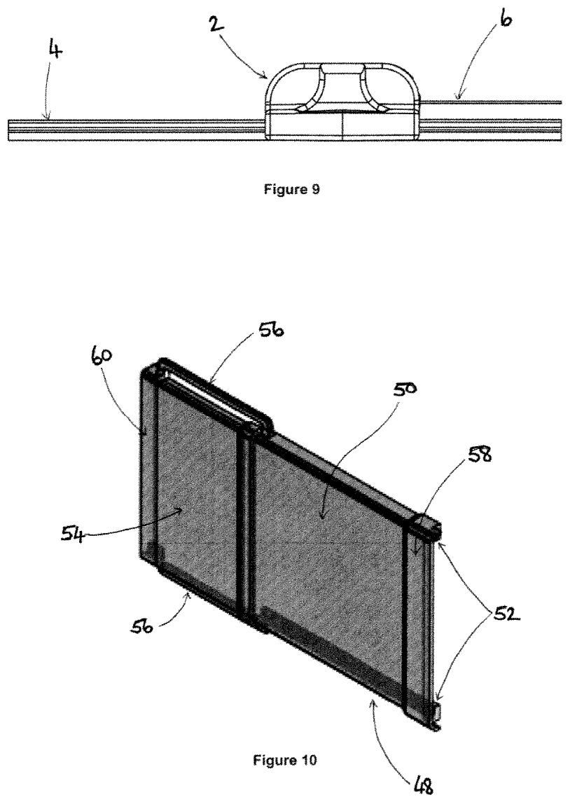

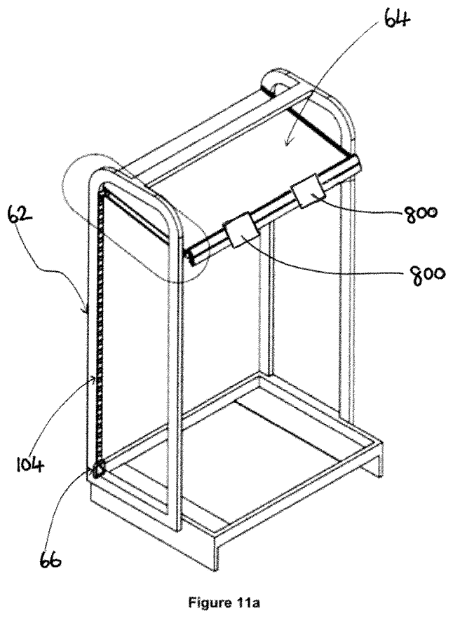

The various aspects of the present invention will now be described with reference to FIGS. 1 to 11c. The apparatus is suitable for providing a shelving system with a supply of power and/or data, and is particularly suitable for use in a retail store, for providing power and/or data to networked electronic devices such as electronic shelf label displays.

The apparatus comprises a connector 2 for an electrically conductive track 4. In the preferred embodiment shown in the Figures, the connector 2 comprises a ribbon cable 6, which contains four electrically conductive wires in an electrically insulating cable sheath. Four resilient electrical contacts 8 are coupled to the end of the ribbon cable, such that each contact is electrically connected to one of the four conductive wires in the ribbon cable.

As shown in FIG. 1, each resilient electrical contact 8 is formed from metal, such as steel, aluminium, copper, phosphor bronze or tin plated phosphor bronze, and comprises a flat portion 10, four piercing elements 12 and a convex portion 14 that is curved so as to form a leaf spring. In order to form an electrical connection to a wire in the ribbon cable, a portion of the cable sheath is removed from the underside of the cable to expose the wire. The flat portion of the electrical contact is brought into contact with the exposed wire, and attached to the cable by piercing the piercing elements through the cable sheath. The piercing elements are then folded down to hold the electrical contact in position on the end of the ribbon cable.

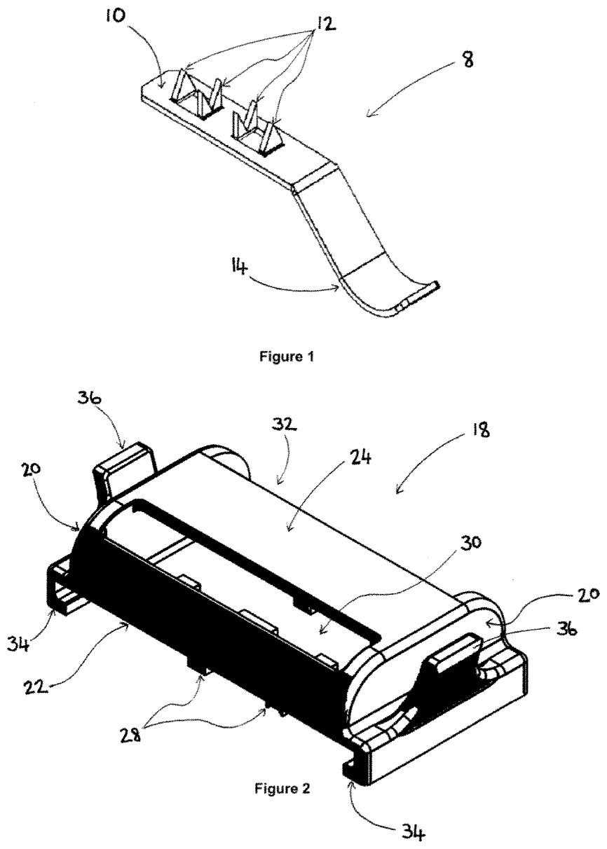

The connector also comprises a housing 16, which is formed from electrically insulating material, for example a polymer or plastic such as polyoxymethylene (POM). The housing comprises a main portion 18, as shown in FIGS. 2, 3 and 4, comprising two end walls 20 connected by three ribs: a front rib 22, an upper rib 24 and a base rib 26. The length of the ribs, and therefore the separation of the two end walls, is approximately 30 mm, which corresponds to the width of the track 4. The upper rib forms the roof of the connector, while the front rib forms the front wall and part of the base of the connector. The flat base rib also forms part of the base of the connector, which abuts the surface of the track when the connector is engaged with the track. The undersides of the front rib and the base rib are asymmetrically keyed with protrusions 28 so that the housing will only fit with the corresponding keyed portions of the track when the connector is engaged with the track in the correct orientation. A gap between the front rib and the base rib forms an opening 30 in the base of the connector, wherein the opening is sized to receive the four resilient electrical contacts. A gap between the base rib and the upper rib forms an aperture 32 in the housing, such that the aperture is opposite the front rib. Each end wall of the housing also comprises a resiliently deformable retaining arm 34, which protrudes below the base rib of the housing and curves inwardly with respect to the housing. Each end wall also comprises a handle 36 coupled to the retaining arm, such that movement of the handles inwards towards the end walls resiliently deforms the retaining arms away from one another.

As shown in the partially-exploded view of FIG. 5, the connector housing also comprises a retaining portion 38, in the form of a wedge, which is releasably engageable with the aperture of the main portion. The retaining portion is resiliently deformable, such that it may be compressed and inserted into the aperture of the main portion. A notch 39 in the upper side of the retaining portion is shaped to correspond with the upper rib of the main portion, so that when the retaining portion reaches an inserted position the upper rib engages with the notch, allowing the retaining portion to resiliently expand to its original shape. With the upper rib engaged with the notch, the retaining portion is retained in the main portion of the housing. The retaining portion is releasable from the main portion by compressing the resiliently deformable wedge so that the notch and the upper rib disengage, allowing the retaining portion to be removed from the aperture.

In order to assemble the connector, one end of the ribbon cable 6 is inserted into the main portion of the housing through the aperture, such that the four electrical contacts 8 are contained within the housing, with the convex portion of the electrical contacts protruding through the opening on the base of the housing. The retaining portion 38 is then inserted into the aperture above the ribbon cable, such that the ribbon cable and the flat portions of the electrical contacts are retained between the retaining portion and the base rib by the force of friction. With the retaining portion in its inserted position, the electrical contacts are retained in the housing such that the curved convex portions protrude out of the opening in the base of the housing.

The electrically conductive track 4 is substantially larger in a longitudinal direction than in a lateral direction, such that the track is much longer than it is wide. The track comprises four electrically conductive ribbon conductors 40 embedded in an electrically insulating base 42. The ribbon conductors run parallel to one another along the track and are laterally separated by protrusions 44 which are keyed to fit with corresponding keyed protrusions 28 on the connector. A retaining lip 46 runs along each longitudinal edge of the insulating base.

The ribbon conductors are formed from a metal, for example copper, tin-plated copper, phosphor bronze or tin-plated phosphor bronze, and are substantially the same width as the resilient electrical contacts of the connector. The insulating base is formed from a plastic material, for example polyoxymethylene (POM)

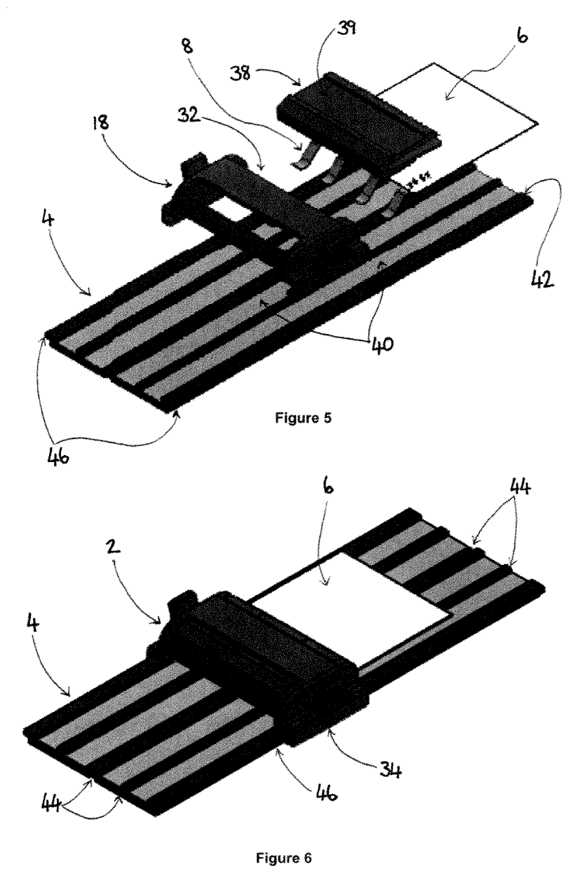

In FIGS. 6 to 9, the connector 2 is shown engaged to the track 4.

In use, the connector is engaged with the track by way of a clip-on mechanism. In order to engage the connector with the track, the two connector handles 36 are moved towards each other in a ‘pinching’ movement, which resiliently deforms the retaining arms 34 to increase the distance between them. The connector is then placed on the track so that the base rib and the front rib of the housing abut the track, and the keyed protrusions 28 on the housing mate with the keyed protrusions 44 on the track. As the connector and the track are asymmetrically keyed, if the connector were rotated through 180 degrees, the keyed protrusions on the connector would not mate with those on the track, preventing the two from engaging. When the connector is placed on the track correctly, the convex portions of the resilient electrical contacts 8 are urged against the ribbon conductors 40 by the housing of the connector, creating an electrical connection. Releasing the two connector handles allows the retaining arms 34 to return to their original shape, such that they engage with the retaining lips 46 on the edges of the track and hold the connector in place.

The connector 2 can be engaged with the track at any position along the track 4, the length of which can be varied as desired. The spring force of the resilient electrical contacts 8 is preferably such that, on application of a force by a user, such as when a user is removing a shelf from a shelf support, the connector may be moved longitudinally along the track while still engaged to the track, and without damaging the ribbon conductors. The engaging surfaces of the retaining lip 46 and retaining arms 34 are advantageously slightly rounded and sized so that if, while engaged with the track, the connector experiences a significant force away from the track, the retaining arms will resiliently deform so as to disengage from the track without breaking.

In order to release the connector from the track, in use, the two connector handles 36 are moved towards each other in the same ‘pinching’ movement, so as to resiliently deform the retaining arms 34 so that they disengage from the retaining lips on the track. The connector can then be removed from the track.

Preferably, the system according to the present invention comprises an electrically insulating track-cover 48, as shown in FIG. 10. The track cover is formed from electrically insulating plastic and comprises a flat upper surface 50 with and substantially the same lateral width as the track 4. The track-cover also comprises two resiliently deformable retaining arms 52, one disposed along each longitudinal edge of the track-cover, which extend at right angles to the upper surface and are curved inwardly towards one another. One end of an openable portion 54 of the track-cover is connected to the upper surface by a living hinge, such that the openable portion may be opened to expose an opening in the track-cover. Two side-ribs 56 connect the longitudinal edges of the track-cover on either side of the openable portion. The ribs are shaped such that the lateral width of the opening is greater than the lateral width of the upper surface of the track-cover, so that a connector may connect to the track through the opening. The track-cover comprises one flared end 58 and one non-flared end 60, wherein the flared end is sized to fit over the non-flared end of an adjacent track-cover. Thus, a plurality of identical track-covers may be combined in a modular fashion so as to cover various lengths of electrically conductive track.

In use, a track-cover 48 may be engaged with the electrically conductive track 4 so as to cover the ribbon conductors 40. A user may engage the track-cover with the track by sliding the track-cover on to the end of the track, such that the retaining arms 52 of the track-cover engage with the retaining lips 46 of the track. Alternatively, the track-cover may be engaged with the track by resiliently deforming the retaining arms and clipping the track-cover onto the track. A plurality of track-covers may be used to cover a length of track, so that the openable portion 54 of each track-cover provides a possible connection point to the electrically conductive track 4.

In order to engage a connector 2 with the track 4, in use, the openable portion 54 may be opened, and the connector may be clipped on to the track through the opening.

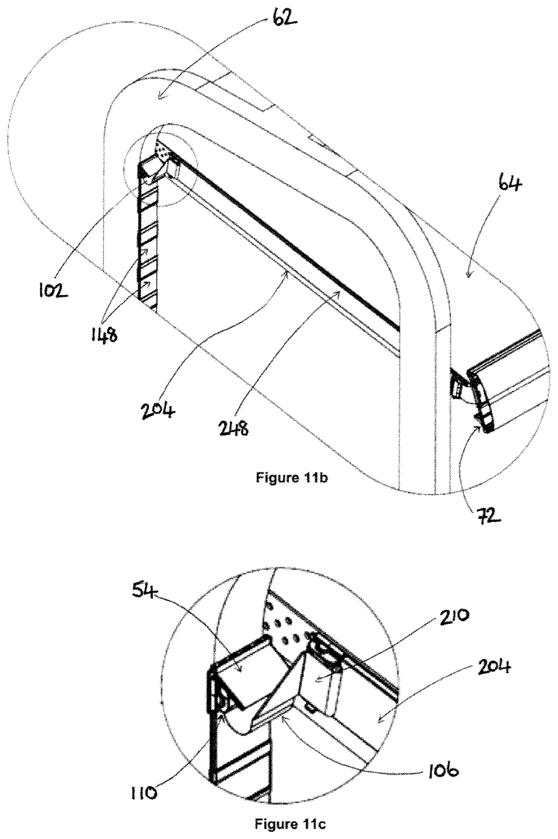

FIG. 11a shows an electronic shelving display system, or electronic shelving system, according to the present invention, with an electrically conductive track 104 mounted to a shelf support 62 and a shelf 64 mounted on the shelf support. A power and data supply 66 mounted at the base of the shelf support supplies power and data to the ribbon conductors on the electrically conductive track, which is covered by a plurality of track-covers 148. The openable portions 54 of the track-covers correspond to a plurality of positions at which shelves may be mounted on the shelf support, and allow a number of positions at which a connector may engage with the track.

FIGS. 11b and 11c show magnified images of the electronic shelving system of FIG. 11a, which comprises a double-ended connector 102. The double-ended connector comprises a single flexible ribbon cable 106 with a first housing 110 at a first end of the cable and a second housing 210 at a second end of the cable. The first housing is engaged with the electrically conductive track 4 on the shelf support through an opening in the track-cover, while the second housing of the double-ended connector is engaged with a third electrically conductive track 204. The third electrically conductive track 204 is mounted along the edge of the shelf from the rear of the shelf to the shelf front. A portion of the second electrically conductive track is exposed at either end of the track to allow engagement of a connector, while the majority of the track is covered by a second track-cover 248 which comprises no openable portions. At the shelf-front end of the third track, a second connector is engaged with the third electrically conductive track, providing an electrical connection from the third track to a display mount 72 on the shelf front.

Two networked electronic shelf edge displays 800, which may be termed networked display devices, are mounted on the display mount 72 on the shelf front. The display mount 72 comprises a second electrically conductive track to provide power and data to the electronic shelf edge displays, so that the displays display information based on the data received.

In use, the power and data supply 66 supplies electrical power at a voltage of 15V and a current of 5 A in a direct current (DC) configuration, and data in an appropriate data format, such as 4xRS485 data format, for electronic shelf label displays.

Alternatively, the power and data supply 66 may supply electrical power at a voltage of 12V, or 24V, according to the requirements of the system.

The shelving system preferably comprises a plurality of shelves mounted on the shelf support.

In use, shelves may be removed from the shelving system by disengaging the first housing of the double-ended connector from the electrically conductive track and removing the shelf. The connector may be removed from the shelf by disengaging the second housing of the double-ended connector from the second electrically conductive track.

In order to replace the shelf in the same, or a different, position the shelf is placed on the shelf mount and one end of a double-ended connector is engaged to the rear end of the second electrically conductive track. An openable portion of the track cover is opened at a position corresponding to the height of the shelf, and the other end of the double-ended connector is connected to the electrically conductive track through the opening, so as to provide an electrical connection from the electrically conductive track to the second electrically conductive track. With these connections in place, power and data is conducted from the power and data supply to the electrically conductive track, through the connector to the second electrically conductive track, and through the second connector to the display mount, from which it is delivered to any electronic shelf label displays mounted on the display mount.

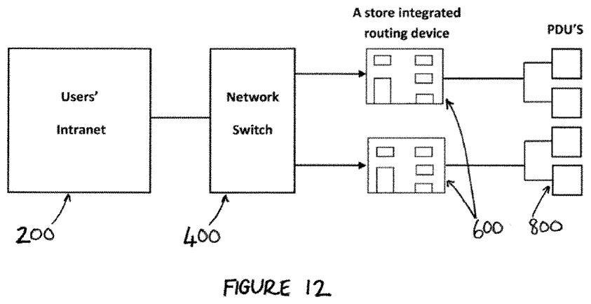

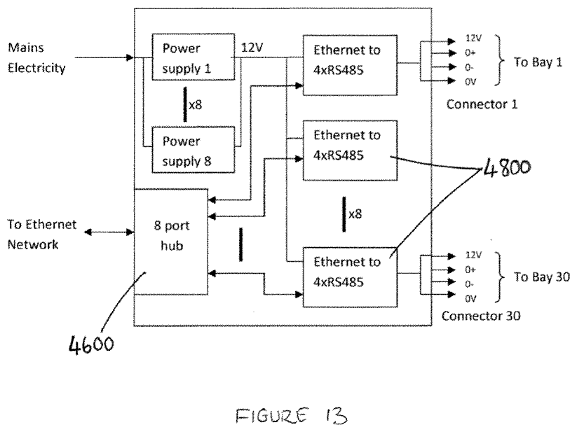

In the system architecture shown in FIG. 12, data comprising product information is entered into the users' intranet 200, at a central computer. This data is then sent to a network switch 400, from which point the data is distributed to one or more store integrated routing devices, or routers, 600.

In an alternative embodiment, data may be sent from the users' intranet 200 directly to one or more routers 600 via ‘the cloud’.

Data is distributed from the routers 600 to the networked display devices 800. The system is implemented within a retail store. Different data is delivered to and stored by different intended devices by way of network addresses assigned to each networked device.

The networked devices 800 are electronic shelf label displays 1000, or price display units (PDUs), mounted on a shelving system and distributed throughout the retail store.

FIG. 13 shows a store integrated routing device 600. Power is supplied to this device from mains electricity, typically at 240V AC. Adapters forming part of the routing device rectify and reduce the voltage of this power supply to a 15V DC supply, which is then supplied to in-built routers 4800. The integrated routing device receives data from network switch 400 via an Ethernet network. Received data is split via an 8 port hub 4600 and converted to an appropriate output format, such as 4xRS485 data format, by the in-built routers 4800. Power and data are output from the integrated routing device and supplied to the appropriate system location through 4 wires (2 for power, 2 for data). Each router 4800 advantageously routes only the data intended for a number of defined shelf supports, or display mounts. Due to the decay over distance of low voltage direct current signals, integrated routing devices are advantageously located near to the display mounts to which they are delivering power and data. Each aisle may be served by one or more integrated routing devices.

If a store, or a multi-store business, wishes to update pricing information for one or more products, the pricing data can be simply routed to the appropriate display unit using this system. Furthermore, advertising or promotional media may be sent to particular displays within the store, as desired. There is no need to replace batteries in the display units and displays and associated products can be easily located owing to the network address of the display, which can be used to find the particular aisle and bay in which the display is located.

1. An electronic shelving display system comprising:
at least one shelf support;
at least one electrically conductive track, comprising a plurality of electrically conductive elements, mountable to the shelf support;
at least one connector for an electrically conductive track; and
at least one shelf;
wherein the connector is a double-ended connector comprising one or more cables; at least one electrical contact coupled to each cable; and first and second housings configured to engage a track and urge the electrical contacts into contact with the electrically conductive elements; and wherein the connector is releasably engageable with the electrically conductive track to provide an electrical connection to allow for the supply of power and/or data to the shelf.

2. An electronic shelving display system according to claim 1, wherein the electrically conductive elements are ribbon conductors.

3. An electronic shelving display system according to claim 1, wherein the track and the connector are keyed so that the connector is engageable with the track only in a predetermined orientation.

4. An electronic shelving display system according to claim 1, wherein the at least one electrical contact is resiliently deformable.

5. An electronic shelving display system according to claim 4, wherein the at least one electrical contact comprises a leaf spring.

6. An electronic shelving display system according to claim 1, wherein the connector is engageable with the track by way of a slide-on mechanism.

7. An electronic shelving display system according to claim 1, wherein the track comprises at least one retaining lip.

8. An electronic shelving display system according to claim 7, wherein the housing comprises at least one retaining arm configured to mate with the retaining lip so as to engage the connector with the track.

9. An electronic shelving display system according to claim 8, wherein the retaining arm is resiliently deformable.

10. An electronic shelving display system according to claim 8, wherein the housing comprises at least one handle coupled to the retaining arm, movable so as to move the retaining arm for disengagement from the track.

11. An electronic shelving display system according to claim 1, wherein the connector housing comprises a main portion and a retaining portion, and the retaining portion is moveable between a first position relative to the main portion, in which the one or more cables are not retained in the housing, and a second position, in which the one or more cables are retained in the housing.

12. An electronic shelving display system according to claim 11, wherein, with the retaining portion in the second position, the at least one cable is retained between the main portion and the retaining portion.

13. An electronic shelving display system according to claim 11, wherein the retaining portion comprises a resiliently deformable wedge insertable into the main portion.

14. An electronic shelving display system according to claim 13, wherein the retaining portion comprises a notch releasably engageable with the main portion, such that the notch engages with the main portion when the retaining portion is in the second position.

15. An electronic shelving display system according to claim 1 wherein the connector can engage with the track at a plurality of positions along the length of the track.

16. An electronic shelving display system according to claim 1, wherein the at least one resilient electrical contact comprises a convex surface configured to engage the electrically conductive elements.

17. An electronic shelving display system according to claim 1, wherein at least one electrically conductive element is used for the transmission of power and at least one electrically conductive element is used for the transmission of data.

18. An electronic shelving display system according to claim 1, additionally comprising an electrically insulating track-cover.

19. An electronic shelving display system according to claim 18, wherein the track-cover comprises at least one retaining arm configured to mate with the retaining lip so as to engage the track-cover with the track.

20. An electronic shelving display system according to claim 18, wherein the track-cover comprises at least one openable portion, through which the connector may connect to the track.

21. (canceled)

22. An electronic shelving display system according to claim 1, comprising a second electrically conductive track mountable to the shelf, wherein the second electrically conductive track comprises an electrically conductive track according claim 1.

23. An electronic shelving display system according to claim 22, wherein the first housing is engageable to the electrically conductive track, and the second housing is engageable to the second electrically conductive track, so as to provide an electrical connection between the two tracks.

24. An electronic shelving display system according to claim 1, comprising an electronic shelving display mount mounted to the shelf.

25. An electronic shelving display system according to claim 24, wherein the electronic shelving display mount comprises a third electrically conductive track.

26. An electronic shelving display system according to claim 24, comprising one or more electronic shelf label displays mountable to the electronic shelving display mount.

27-50. (canceled)

51. A connector for an electrically conductive track comprising:
one or more cables;
at least one electrical contact coupled to each cable; and
a housing configured to engage a track and urge each electrical contact into contact with the track;
wherein the connector is releasably engageable with the track; and
wherein the connector is a double-ended connector comprising a first housing and a second housing.

52. A connector for an electrically conductive track according to claim 51, wherein the connector is configured to releasably clip on to a track.

53. A connector for an electrically conductive track according to claim 51, wherein the connector is configured to releasably slide on to a track.

54. A connector for an electrically conductive track according to claim 51, wherein the at least one electrical contact is a resiliently deformable electrical contact.

55. A connector for an electrically conductive track according to claim 54, wherein the at least one resilient electrical contact comprises a leaf spring.

56. A connector for an electrically conductive track according to claim 51, wherein the housing comprises at least one retaining arm configured to engage with a retaining lip on a track.

57. A connector for an electrically conductive track according to claim 56, wherein the at least one retaining arm is resiliently deformable.

58. A connector for an electrically conductive track according to claim 56, wherein the housing comprises at least one handle coupled to the retaining arm, wherein movement of the at least one handle moves the retaining arm so as to disengage the arm from a track.

59. A connector for an electrically conductive track according to claim 51, wherein the housing comprises a main portion and a retaining portion, and the retaining portion is moveable between a first position relative to the main portion, in which the one or more cables are not retained in the housing, and a second position, in which the one or more cables are retained in the housing.

60. A connector for an electrically conductive track according to claim 59, wherein, with the retaining portion in the second position, the at least one cable is retained between the main portion and the retaining portion.

61. A connector for an electrically conductive track according to claim 51, comprising a plurality of resilient electrical contacts spaced laterally from one another.

62. A connector for an electrically conductive track according to claim 51, wherein each resilient electrical contact is configured to contact a corresponding electrical conductor on a track.

63. A connector for an electrically conductive track according to claim 51, wherein the connector is keyed to fit a corresponding portion of a track.

64. A connector for an electrically conductive track according to claim 51, wherein the one or more cables comprise a ribbon cable.

65-76. (canceled)
